(19) United States
(12) Patent Application Publication
(10) Pub. No.: US 2007/0016645 A1
(43) Pub. Date: Jan. 18, 2007

(54) System and method of composing search free mail

(76) Inventor: Hong Na, McLean, VA (US)

Correspondence Address: LITMAN LAW OFFICES, LTD, PO BOX 15035, CRYSTAL CITY STATION, ARLINGTON, VA, 22215, US

(21) Appl. No.: 11/181,853

(22) Filed: Jul. 15, 2005

(51) Int. Cl. G06F 15/16

(52) U.S. Cl. 709/206

(57) ABSTRACT

The method of composing search free mail is a web-based method for sending e-mail to registered members of a search free mail domain. The method uses a web server and a mail server as components of the search free mail domain. Registered members have assigned mailboxes on the mail server. The web server generates a publicly assessable web page through which system users may enter a member's telephone number and gain access to a business ad web page for the member. At the business ad web page, a user may operate a button or link causing the web server to generate a web-based interface for composing and sending an e-mail to the member's mailbox. The business ad web page is customized by the member and may include information about the member's business and interests as well as a link to the member's company or business web page.

### BACKGROUND OF THE INVENTION

1. Field of the Invention

The present invention relates to an electronic communication system, and particularly to a system and method for composing, sending and receiving search free user e-mail.

2. Description of the Related Art

Various systems are in use for communicating electronically over the Internet. E-mail systems are particularly popular for exchanging business communications. In a conventional e-mail system, a sender composes an e-mail using an e-mail client program, addressing the e-mail using the intended recipients e-mail address. Typically e-mail addresses are composed of a combination of the recipient's identity, such as some portion of the user's name, combined with a domain portion, which designates the system hosting the mailbox the recipient uses to receive e-mail. For example a recipient, John Smith, might have an e-mail address, such as johnsmith@aol.com, wherein the initial or personal identifier portion of the address “johnsmith” is a concatenation of John's first and last names, while the trailing portion “aol.com” is the domain name of the system hosting John's mail box. When the sender completes composing the e-mail and sends the e-mail to the recipient using a system such as Simple Mail Transfer Protocol (SMTP), the domain portion of the e-mail address is resolved to an Internet Protocol (IP) address using a dynamic name server (DNS) system. The IP address is used to route the e-mail to the destination server. The initial portion of the address is used to locate the recipient's mailbox on the destination server.

Two issues are associated with these conventional e-mail systems. The first issue is that a sender may have difficulty in determining the recipient's address, and a second issue is the problem of receiving large amounts of unwanted e-mail when an e-mail address is made public.

In order to send an e-mail to a recipient, the sender must obtain both the personal and the domain portion of the e-mail address. One strategy is for the recipient to register an e-mail address that is easy for senders to construct by using a domain name and a personal identifier that portion that are simple combinations of the sender's name and organization. However, personal names are not globally unique identifiers so that a natural permutation of the personal name may result in the mail reaching the wrong person at a given domain. Adding numeric characters to the personal name in order to distinguish the mailboxes of persons with similar names makes the e-mail address more difficult for senders to remember and impossible for them to guess.

In addition, natural choices for e-mail addresses may be unavailable because of cyber-squatting. Cyber-squatting is the practice of registering a domain name that another person might chose with the purpose of offering that person usually for monetary gain.

If an e-mail user succeeds in making his e-mail address publicly available so that senders can contact him, the user must then deal with the problem of unwanted e-mails. E-mail marketers attempt to harvest e-mail addresses using various methods, compile those e-mails into mailing lists and then send out unsolicited, bulk, and e-mail advertisements, commonly referred to as “spam” using these mailing lists that may include millions of addressees. Since the typical spamming advertising campaign has a low success rate, bulk e-mailers rely on sending their advertisements in large volumes. Many e-mail users receive spam on a daily bases and in some cases users spend a significant portion of their time dealing with unwanted e-mails which consume storage resources and bandwidth in the users' systems and cause inefficiencies in dealing with desired e-mail communications. E-mail recipients may address the problems of spam by using filter systems to automate the process of screening e-mails, but filter systems may not reject all spam and may also misidentify desired e-mail communications as spam resulting in missing desired communications.

In addition to solving these problems, business users view communication activities as opportunities to further their business interests. When a sender attempts to contact a recipient, the recipient may want to provide information to the sender concerning the recipient's interests or business.

E-mail providers such as Yahoo.com and MSN.com provide membership based e-mail services which require members to login to access their e-mail, but these systems are susceptible to spamming and do not provide opportunities for mail recipients to display a personalized business ad web page to senders who wish to contact them.

Japanese Patent No. 2003-69,708, published March 2003, describes a system for relating a telephone number to an e-mail address using a translation database. Japanese Patent No. 2004-64,758, published February 2004, describes a method of associating a phone number with an e-mail address for the purpose of receiving e-mail messages at a telephone.

None of the above inventions and patents, taken either singly or in combination, is seen to describe the instant invention as claimed. Thus, a system and method of composing search free mail solving the aforementioned problems is desired.

### SUMMARY OF THE INVENTION

The system and method for composing search free mail is a web-based method for sending e-mail to registered members of a search free mail domain. The method uses a web server and a mail server as components of the search free mail domain. Registered members have assigned mailboxes on the mail server. The web server generates a publicly assessable web page through which system users may enter a member's telephone number and gain access to a business ad web page for the member. At the business ad web page, a user may operate a button or link causing the web server to generate a web-based interface for composing and sending an e-mail to the member's mailbox. The business ad web page is customized by the member and may include information about the member's business and interests, as well as a link to the member's company or business web page.

A sender desiring to compose and send e-mail to a registered member of the search free mail system accesses the member's business ad web page by entering a member's identifier at a log-in web page. The member's identifier is preferably a publicly available telephone number belonging to the member. Once the member's identifier is entered, the system displays the member's business ad web page on the user's computer. The member's business ad web page contains information concerning the business and interests of the member. Requiring senders to visit the web page in order to send mail to the user allows the member a chance to communicate information to users, which could result in more business opportunities for the member. Requiring senders to visit the web page in order to send mail to the user also prevents bulk e-mail advertisers from sending e-mail to the member's account. The business ad web page may contain a link to the member's business or company web page.

The search free mail system provides for registering users as members of the system. The log in page includes a button or link for a user to request registration. To accomplish registration, the user enters his telephone number at the login web page and sends a request to be registered as a member. The system prompts the member to provide a password, and then assigns a mailbox for the user, storing the password, mailbox location, and member identification so that the password and mailbox location can be retrieved by providing the member's identification. The new member is then prompted to design or provide a business ad web page. The business ad web page is stored on a server within the system and is associated with the member's identification, and the location of the web page is also stored so that the web page may be retrieved using the member's identification.

The operator of the system may require payment for providing membership to the system. The system may request the member to provide a method of payment, such as a billing address or a credit card account number, before completing the registration.

The system reserves some functionality for members. A member may access his mailbox by entering his telephone number and password using a web-based interface. The member will then be provided with a user interface for managing aspects of his account on the search free mail system. Using the password-protected user interface, the member may access mail in his mailbox, compose e-mails to be sent to other members or to external e-mail addresses, and modify the design of the member's business ad web page. Mail sent by the member is automatically provided with a ‘From’ address of the member. To send mail to one or more members, the member specifies the member identifiers for those members.

These and other features of the present invention will become readily apparent upon further review of the following specification and drawings.

### BRIEF DESCRIPTION OF THE DRAWINGS

FIG. 1 is a block diagram of a network environment in which the method for composing search free mail of the present invention may be practiced.

FIG. 2 is a block diagram of a representative computer on which the method of composing search free mail of the present invention may be practiced.

FIG. 3 is a block diagram showing services available in the system for composing search free mail according to the present invention.

FIG. 4 is a screen shot showing a representative entry point web page for accessing the search free mail system according to the present invention.

FIG. 5 is a screen shot showing a representative business ad web page for a member of a search free mail system of the present invention.

FIG. 6 is a screen shot showing a representative page for composing an e-mail by a non-member in a search free mail system according to the present invention.

FIG. 7 is screen shot showing a representative page on which a search free mail member manages e-mail in the search free mail system of the present invention.

FIG. 8 is a screen shot of a representative new member sign up page for a search free mail system according to the present invention.

FIG. 9 is a screen shot showing a representative new member's initial web page in a search free mail system according to the present invention.

FIG. 10 is a block diagram of showing the sending and receiving of search free mail between a member and either a non-member or another member of a system for composing search free mail according to the present invention.

FIG. 11 is a block diagram showing messaging to a conventional e-mail system from a system for composing search free mail according to the present invention.

FIG. 12 is a screen shot illustrating a representative fortune telling page in a system for composing search free mail according to the present invention.

FIG. 13 is a screen shot showing a representative page for composing an e-mail by a registered member in a search free mail system according to the present invention.

Similar reference characters denote corresponding features consistently throughout the attached drawings.

### DETAILED DESCRIPTION OF THE PREFERRED EMBODIMENTS

The present invention is a method and system for receiving search free mail and for presenting a business ad web page to e-mail senders. The invention may be practiced in conjunction with a search free mail system employing country-specific native domains, such as the system described in U.S. Pat. No. 6,728,759, issued to the present inventor and hereby incorporated by reference in its entirety.

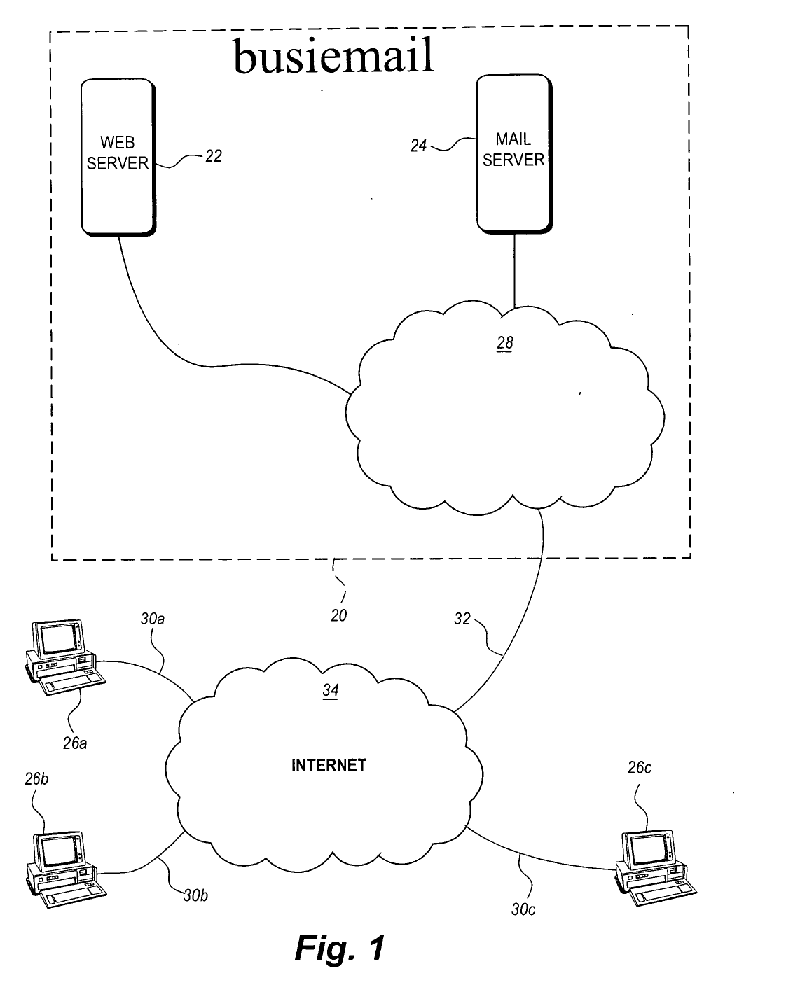

The invention may be practiced on a network system, such as the system illustrated in FIG. 1. FIG. 1 shows a search free mailing domain 20 named “Busiemail.com”. The domain 20 comprises a web server 22, and a mail server 24 connected to a local or wide area network 28. The domain 20 is connected to the Internet 34 via a high-speed link 32.

The web server 22 may comprise one or more computers. The web server 22 includes application programs for generating web pages and serving data and information upon demand using a protocol such as hypertext transfer protocol (HTTP). The web server 22 also includes non-volatile storage for storing data structures associated with the invention. Application programs stored in the web server 22 also process data provided to the web server 22 via HTTP command or through other protocols. This data may be stored, utilized to generate customized web pages, or used to customize functions provided by the web server 22.

The mail server 24 contains facilities for receiving and sending e-mail messages over the Internet. The mail server 24 may implement a protocol such as Simple Mail Server Protocol (SMTP) for sending and receiving electronic messages. The mail server 24 also includes non-volatile storage such as hard drive based storage for storing electronic messages in a mailbox for users or clients of the search free mail system.

Also shown are a number of user computers 26a-26c connected to the Internet via a number of communication links 30a-30c. These communication links may be wired or wireless. Alternatively, the user computers 26a-26c may be connected to a local area network, which is in turn connected to the Internet via a wired or wireless link. Preferably the user communication links 30a-30c are broadband connections to the Internet such as a cable modem or DSL connection. However dialup modem connections and other lower speed connections to the Internet may also be employed. The user computers 26a-26c are shown as personal computers, but other computing devices such as personal digital assistants (PDAs), mobile telephones, capable of rendering a web page may be used as the user computer.

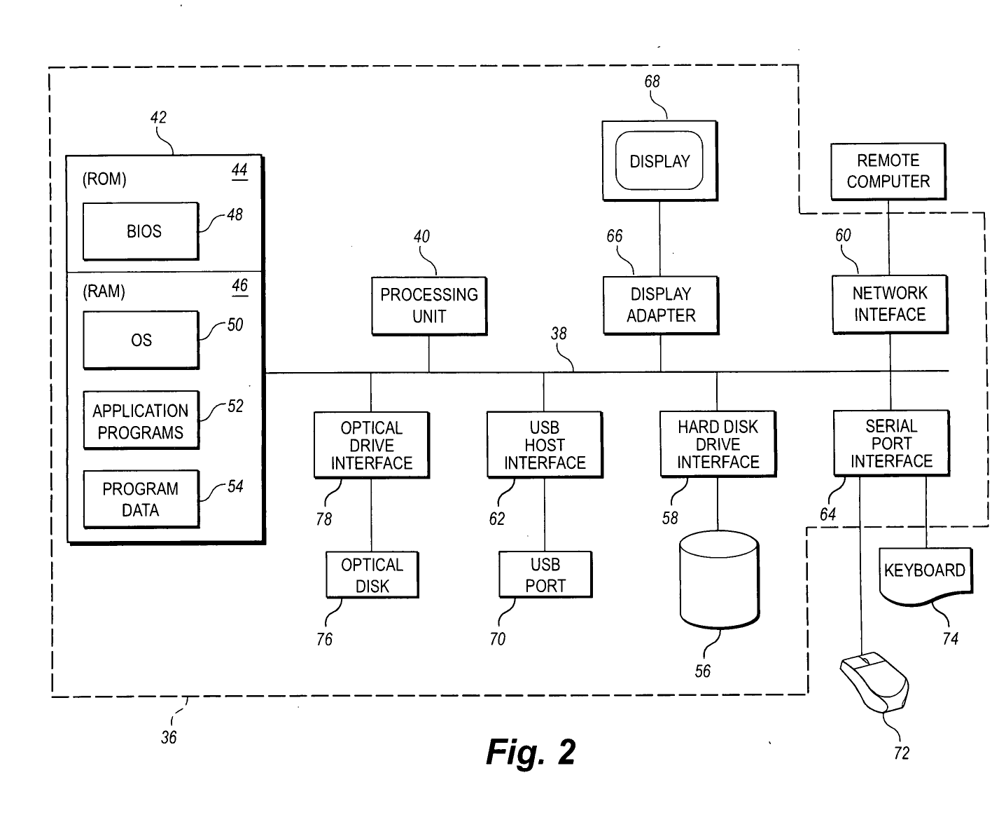

FIG. 2 illustrates a computer system 36 such as may be used for the user computers 26a-26c or the web server 22 or mail server 24 shown in FIG. 1. The computer system 36 includes a system bus 38 that interconnects various elements making up the computer 36. A processor subsystem 40, a system memory 42, and a number of interface and adapter systems supporting the connection of system and external devices to the computer are connected to the system bus 38.

The system bus 38 may be comprised of a number of bus subsystems. For example a PCI bus, an ISA bus, and an AGP connection system may be provided. The system bus provides the means for moving data between the various components of the personal computer 36.

The processor subsystem 40 comprises one or more central processing units (CPU). The processor subsystem directs the overall operation of the computer by retrieving and executing logical and arithmetic instructions and issuing commands to control other computer components. The system memory 42 may comprise read only memory (ROM) 44 and random access memory (RAM) 46 components. The ROM 44 includes the basic input/output system (BIOS) 48. The BIOS 48 includes routines that are performed to initialize the computer during startup and to conduct low-level operations between system components. The RAM 46 may store the operating system 50, and may store instructions and data for executing application programs in the application program 52 and program data 54 areas. The operating system may be a general-purpose operating system such as Microsoft's XP, or Linux, or a special purpose operating system adapted and optimize for a particular application or processor. The information stored in the RAM 46 may be loaded from a non-volatile storage area such as ROM 44 or a hard drive 56 during startup of the system or upon initiation of an application program.

Additional elements connected to the system bus 38 may include a display adapter 66, a network interface 60, a USB host interface 62, a hard disk drive 58 interface, and a serial port interface 64. The display adapter 66 provides an interface for connecting an external monitor 68 to the computer. The network interface 60 provides a network connection capability allowing the computer to communicate to remote devices through a local area network, an intranet or the Internet. The USB host controller 62 is connected to the system bus 38 and provides an interface to a USB port 70. The USB port 70 may supply electrical power and a data path for one or more USB compatible peripherals. One or more hard drives 56 may be connected to the computer 36 through the hard disk drive interface 58. The hard drive 56 provides non-volatile storage and may store the operating system, application programs, and program data.

Input devices for accepting data input from users such as a mouse 72, keyboard 74, or trackball (not shown) may be interfaced to the system bus 38 via the serial interface 64. Alternatively a USB compatible keyboard, mouse, or other input device may be connected to the computer via the USB port 70. Additional devices such as an optical disk drive 76 for reading from or writing to a removable optical disk such as a CD-ROM, CD-R, DVD-ROM or other optical media may be connected to the computer through an optical drive interface 78.

Those skilled in the art should appreciate that the list of components given above is not an exhaustive one and that other types of devices can be interfaced to the computer using the interfaces described above or through the use of additional interfaces and controllers connected to the system bus 38. Peripherals devices and associated interfaces and control devices may be omitted if their functionality is not required. For example a server system not requiring interactive user input from a keyboard, may optionally not include peripheral devices such as a keyboard, mouse, or monitor and the associated interfaces for the omitted peripheral devices may also be optionally omitted.

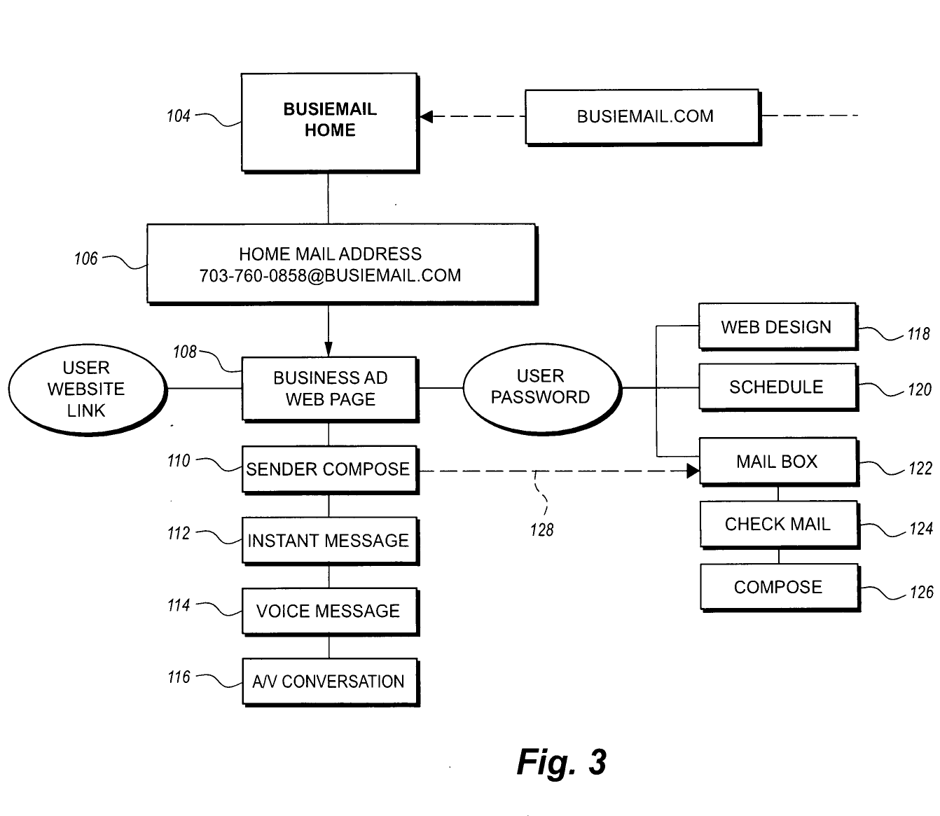

The functions provided by the domain 20 shown in FIG. 1 may be understood by referring to FIGS. 1 and 3. A user at a computer such as 26a, may access the system using a browser such as Microsoft's Internet Explorer, Netscape Navigator, or Opera by Opera Systems, by entering the domains web address at block 102. The web address such as “busiemail.com” or “www.busiemail.com” is resolved to an Internet Protocol (IP) address using dynamic name servers (DNS) as is known in the art, and resulting in the user's request being delivered to the search free mail domain 20 at block 104. The web server 22 receives the request and responds by delivering the entry point web page (business ad web page) to the user computer 26a at block 106.

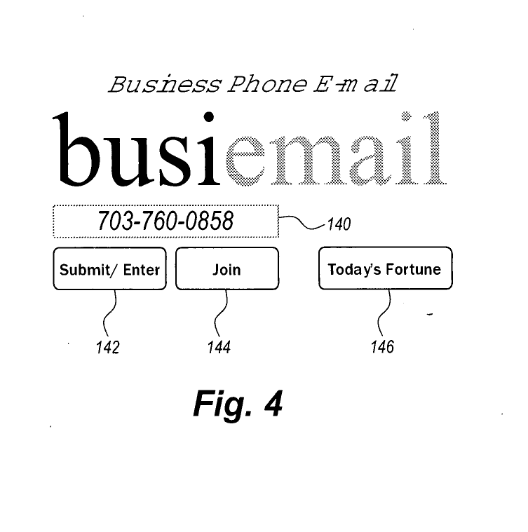

FIG. 4 shows the entry point web page displayed on the users computer 26a. Users may be classified as a current member, a prospective member, a non-member wishing to contact a current member, or a visitor. Each class of user may access selected functionality of the search free mail domain 20. Users may assume various roles when accessing the domain 20. For example a current member may elect to access the search free mail domain as a visitor or as a non-member. However, only members who have completed a registration process as described below may access functions reserved for members.

A member who has completed the registration process will have a registered telephone number, a password, a mail account including a mailbox, and a business ad web page. Any user can access the member's business ad web page can be accessed by any user by entering the member's telephone number in the entry box 140 and clicking the submit or enter button 142. When the submit or enter button 142 is clicked, the web server 22 will locate and retrieve the business ad web page associated with the member's telephone number and return the business ad web page to the user's computer 26a as shown at block 108 in FIG. 3.

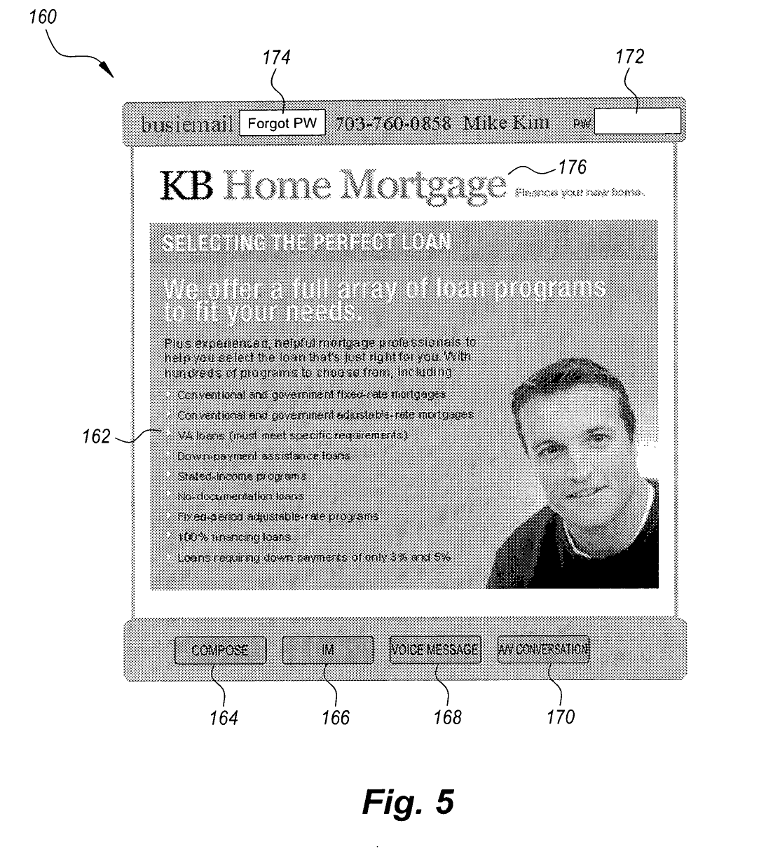

FIG. 5 shows an example member's business ad web page 160. This web page will be displayed both to member's who log in using their own phone number or to non member's who enter the member's phone number in order to communicate with the member. The business ad web page 160 includes a logo or heading 176 describing the business of the member. This logo 176 may include a link to an externally hosted company or business web page of the member. Alternatively a link to the company or business web page may be provided elsewhere on the web page 160 using a conventional URL anchor. The web page contains additional information 162 as provided by the member describing the member's business, interests or any other information specified by the member including an image of the member.

Accessible from the web page are buttons or links that provide access to various communications facilities for communicating with the member. As illustrated in FIG. 3, from the member's web page, a member or a non-member user may communicate with the member by composing an electronic message 110, Instant Messaging (IM) 112, Voice Messaging 114, or through AudioVisual (A/V) conversation 116. These functions are accessed from the member's business ad page 160 using buttons or links 164, 166, 168, or 170, respectively. The A/V conversation is a communication facility employing a web camera (web cam) and microphone to establish two-way communication with a member of the system.

When the user presses the “Compose” button 164 on the member's business ad web page, the user can access a facility to send compose and send an e-mail to that member. As illustrated in FIG. 3, the user can compose and send an electronic mail at block 110 and send it to the member's mailbox as shown in block 122 via path 128. Requiring mail from a non-member to a member's mailbox to be sent via path 128 prevents unwanted bulk electronic mail from being delivered to the member's mailbox. Mail sent via a conventional path over the Internet and to the SMTP mail server (24 in FIG. 1) does not get placed in the member's mailbox. Requiring non-members to log in to the member's business ad page 160 in order to send mail to a member, eliminates non-member advertisers use of bulk mailing techniques (spam) to send mail to a member's search free mail mailbox even if the bulk mailer's address list includes the e-mail address associated with the member's account. This selective reception of electronic e-mail may be accomplished by filtering or dropping e-mail for which the return address is not within the search free domain. Because this filtering method would still allow bulk mailers to circumvent the spam protection by forging a search free domain return address, preferably the mail server 24 could be configured to reject mail delivered via directly over the Internet link rather than via path 128.

As shown in FIG. 3, in order to access functions such as web design 118, scheduling 120, and member mailbox functions 122 such as checking mail 124 and composing mail 126 mail, the member must enter the password associated with the members account at block 130. Presumably only the owner of the member account knows the password.

Referring again to FIG. 5, the member associated with the web page enters his password in the password entry box 172, and submits the request to the search free mail web server (22 in FIG. 1) by pressing the enter key or by clicking a button provided to indicate that password entry is complete. In case the member has forgotten his password, the member may click a provided button or link 174 to communicate to the web server 22 that the password has been forgotten. A system operator for the search free mail domain my contact the member using the registered telephone number or via any other prearranged method of communication. Using the telephone number or a prearranged method helps insure that security of the member's password is maintained.

After receiving the password, system software in the domain server 22 verifies the correctness of the password and provides access to the member's e-mail system if the password is correct. A correct password matches the password registered for the member. The system software may additionally check to make sure the account is active. For example the system may operate the system on a subscription fee basis, requiring periodic payment such as a monthly fee to maintain an active member account. The system may be programmed to condition access to the account based on the account being active. Account and payment status may be maintained in one or more tables in a database with the information being retrievable based on the identification of a specific user. Data stored in the database for each member includes the location of the member's business ad web page, the member's password, any configuration items associated with the member's mail account, the location of the member's mailbox on the mail server, as well as billing and account status information. The tables may be segregated on different computers or different storage areas associated with the web server. For example, sensitive information such as credit card and other billing information may be stored on a server computer not directly accessible over the Internet.

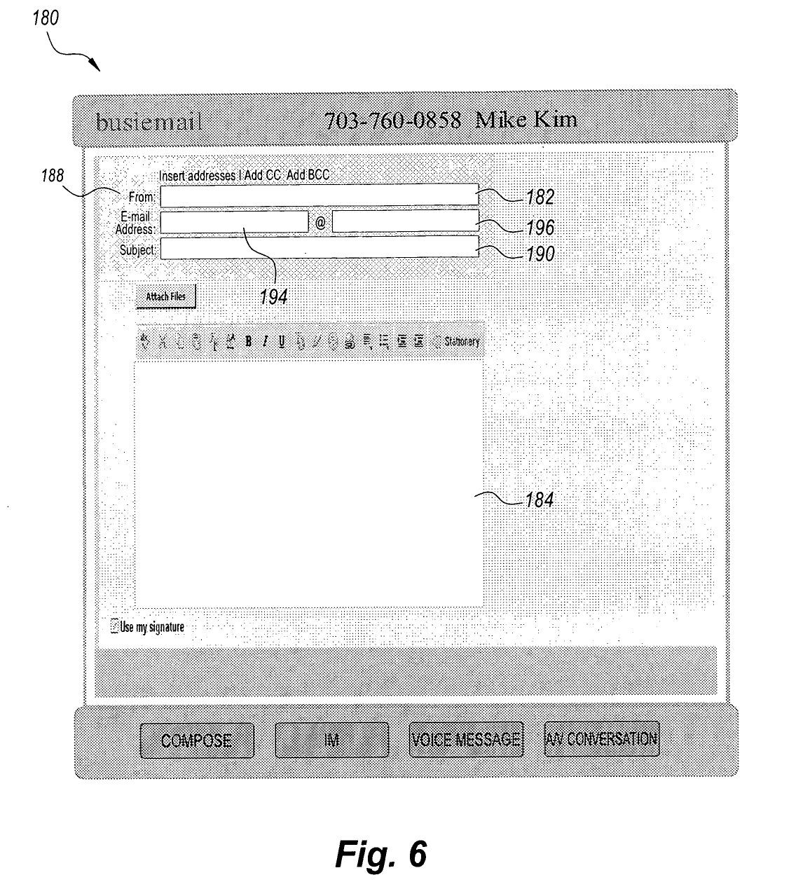

When a user logs in with a member's account number and selects the “Compose” function from the member's business ad web page, the compose e-mail screen 180 shown in FIG. 6 is displayed. For example if a computer user accesses the member's account from computer 26a, the search free mail domain web server will deliver the web page 180 to the users computer 26a where it will be displayed via a conventional browser or using specialized software stored on the user's computer for generating the display 180.

As illustrated in FIG. 6, the title bar 192 indicates the name associated with the member's account, the member being the intended recipient of the mail. Because the recipient is known to be the member, the sender only needs to enter sender's own addressing information in fields 182, 194, and 196. The sender's name is entered in box 182. The personal portion (portion of the e-mail address to the left of the “@” character) of the sender's e-mail address is entered into box 194, while the domain portion (portion of the e-mail address to the right of the “@” character) of the sender's e-mail address is entered in box 196. The address label 188 displays “From” indicating that the address entered is that of the sender. The sender enters a subject line for the message in the subject entry area 190. The sender then types the message into the message entry field 184.

Upon completing the message, the sender may submit the message for delivery to the member using the “SAVE” button 186 which will cause the message to be stored in the addressed member's search free domain mail box. Conventional e-mail features, such as attachment of files to the e-mail and requests for confirmation of receipt by the e-mail recipient, may also be supported. As described above, upon completion, the message is sent over the Internet to the web server 22 via an appropriate protocol, such as HTTP. The web server 22 delivers the mail to the recipient member's mailbox on the mail server 24.

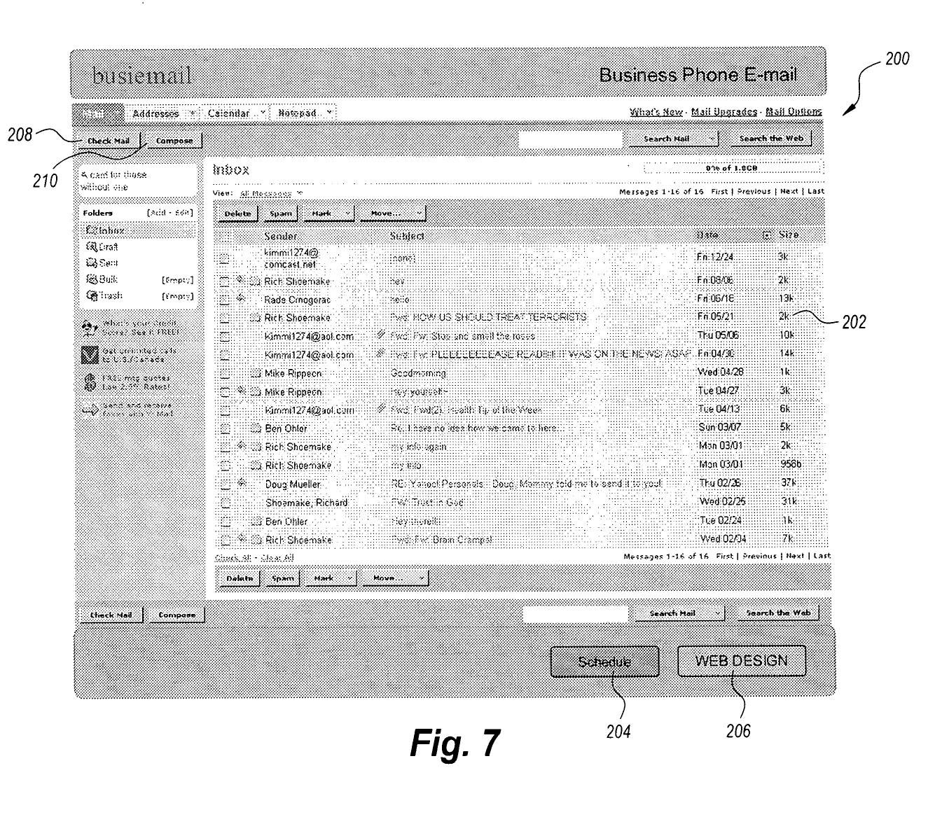

As described above, a member user may access member functions by logging in from the member's computer such as 26b in FIG. 1, using his own telephone number via the login screen shown in FIG. 3, and entering his password at his own business ad web page as shown in FIG. 5. The web server confirms that the password is correct and may also confirm that the member's account is active. A successful confirmation allows the member to access the member's mail account display 200 shown in FIG. 7 from the member's computer 26b. The display is generated and transmitted to the member's computer 26b from the domain web server 22 and is rendered by application software on the member's computer 26b such as a general purpose browser or special purpose client software.

Referring to FIG. 7 the functionality accessible only to a member who has logged in to his own account using his telephone number and password may be understood. The display 200 includes a list 202 of the electronic mail stored in the member's mailbox. The list 202 may include the sender, subject line, the date of receipt and the size for each mail in the sender's mailbox. The list 202 may also indicate other attributes associated with the member's mail such as priority and desire by the sender for confirmation of receipt of a mail item.

The member may manage items in his mailbox from the mailbox display 200. For example, the member may create mailbox subfolders and move mail from his inbox folder to one or more sub folders. The member may designate messages in his mailbox as spam, and may delete mail from his mailbox using controls provided on the display 200. The member may also select an item from the e-mail list 202 to display for reading. These features are restricted to the member associated with a particular account because the member's telephone number and password must be entered in order to reach this screen.

The member may also check the server for newly arrived mail by clicking the check mail button 208, access the member's only compose e-mail function by clicking the member compose button 210, access the web design function by clicking the web design button 206, or access the member's schedule function by clicking the scheduler button 204. Each of these buttons is only accessible by the member owning the account because they are on the password protected mailbox screen 200. For example, the scheduler and compose buttons may be located on a separate display accessible from a button on the mail account screen 200 since these screens cannot be reached without entering the correct member account number and password.

Clicking the “Scheduler” button 204 provides access to an application for maintaining a personal calendar for the member. The calendar program stores information concerning the appointments and meetings of the member. The program store and display information concerning tasks to be completed by the member and birthdays and other special events the member wants to keep track of.

Access to additional member only functions may be provided by including a button, link, or other access mechanism on a password protected interface such as the member's mailbox display 200. For example, access to facilities for changing the member's password, updating billing information, and changing the member's phone number may securely provided by providing a button or link on the member's mailbox display 200.

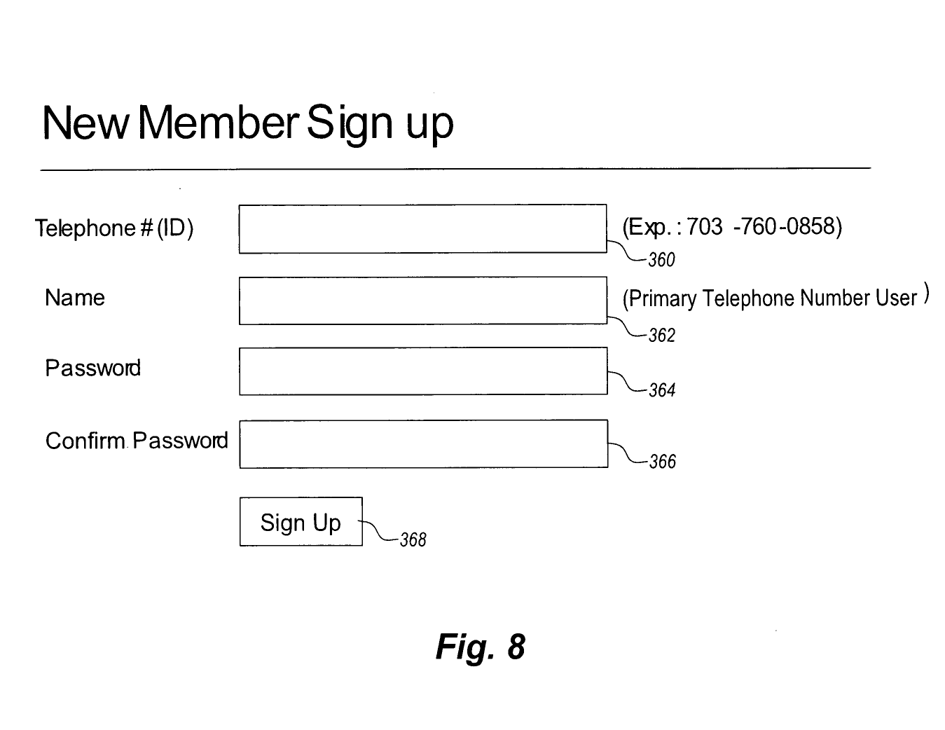

By referring to FIGS. 1, 3, and 8, the process for signing up a prospective member to the search free mail domain may be understood. To access the display shown in FIG. 8, a prospective member would access the search free member domain from a user computer such as computer 26c, resulting in the display from FIG. 3 being sent by the web server 22 to the prospective member's computer 26c where the display is rendered using the prospective member's browser or other application on the member's computer. The prospective member would then use the data entry facilities of computer 26c and application software such as a convention browser to enter the member's telephone number and would then click the “Join” button 144, indicating his desire to become a member of the search free mail domain. The telephone number and the join request are then communicated to the web server using an appropriate protocol such as an HTTP request, and the server would generate and return the data required to generate the display shown in FIG. 8. Application software on the member's computer 26c would render the display and accept user input.

The new member sign up display includes an entry box 360 for entering the member's telephone number. Preferably the telephone number entry box 360 includes the telephone number captured from the initial entry at the log in screen. The account member then enters his name in the name entry box 362. Finally the account member selects and enters a password using the password entry box 364. Preferably, the password is not visibly displayed while being typed into the password entry box 364, but rather non descript characters such as asterisks are typed in allowing the prospective member to keep track of the number of characters entered. In order to guard against a typographic error resulting in the prospective member not knowing what actual password is registered, the prospective member is required to confirm his password by typing the identical password into a confirmation entry box 366. Clicking the “Sign Up” button 368 transmits the new member information to the web server 22. To maintain security of the password information during transport over a public network, information may be transmitted using a secure protocol such as Secure Socket Layer (SSL) or a secure connection such as Secure HTTP (S-HTTP) may be used to transmit the member's sign up data. Secure protocols can be used for any of the data transmissions between user computers and servers required by the invention.

Upon delivery of the new member information to the web server 22, software on the web server 22 verifies completeness and accuracy of the new member information before establishing the member's account. The verification steps include checking that passwords are sufficiently long (have at least a predetermined minimum number of characters, and that the confirmation password matches the initial password. The verification step may include checking that the phone number is a properly formatted number and that a name for the account has been provided. The use of telephone numbers as the identification helps insure that a unique account number is available. Because phone numbers for members are publicly available and are included on the member's business cards and in public directories, the problem with searching for the member's e-mail address is eliminated.

The verification step may further include a request for payment of a subscription fee. The domain name system may further request that a method of payment such as a billing address, a credit card account number or other financial arrangement be made prior to completing the registration. Personalized information collected for billing purposes does not become part of the information displayed with the member's business ad page, but the information is stored securely for retrieval for account billing and account status purposes. Preferably the information is stored so that it is not accessible to unauthorized personnel via the Internet.

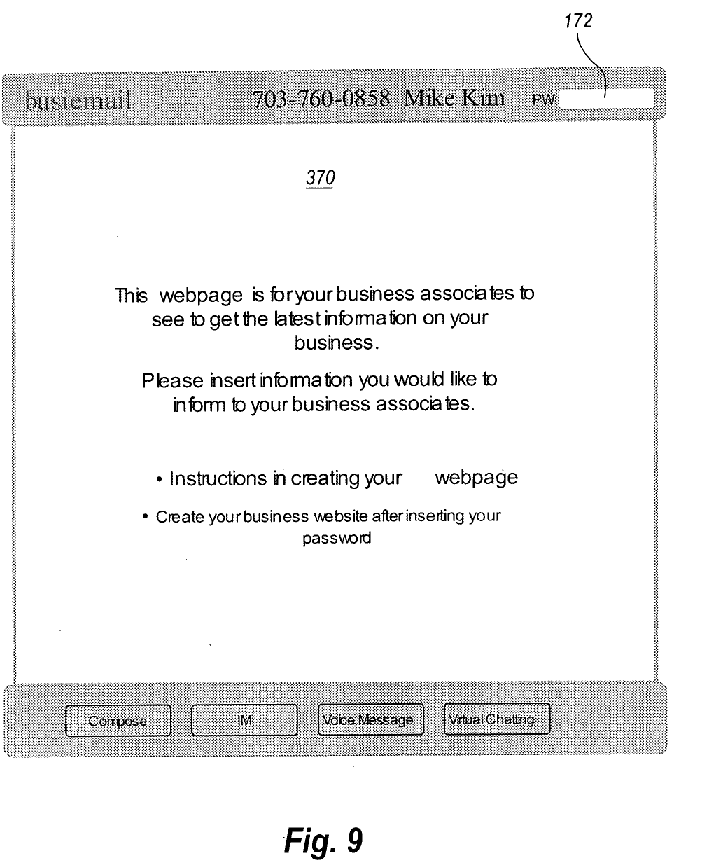

After the prospective member has completed the registration process described above, the prospective member becomes a new member. Because the new member has not yet designed a business ad web page, a default business ad web page as illustrated in FIG. 9 will be displayed to senders who log into the member's web page. Immediately after registration is complete, the web server generates the default web page shown in FIG. 9. The default web page displays instructions 370 detailing the process for creating a new web page.

To access the facilities for creating a new web page, the new member logs in to his mail account by entering his password in the password entry box 172. Upon successfully entering the password, the password is transmitted to the web server, preferably using a secure protocol. If the password matches the new member's chosen password, the web server will allow the new member to access his mail account by transmitting the display illustrated in FIG. 7 to the member's computer 26c where application software on the member's computer 26c renders the display. As described above, members may access the facilities for designing or modifying their business ad web page by clicking the “Web Design” button 206.

The web design facility may consist of conventional tools for designing web pages. For example, clicking the “Web Design” button may start up web page editor such as Microsoft's FrontPage. Alternatively, the member may be instructed to upload a pre-designed web page which the member has designed using any convenient tool. The web design facility may comprise a facility for selecting a template, which the member modifies to suit the member's needs. As another alternative, the member may be presented with a design wizard which queries the member concerning layout options, background, and other choices, and invites the member to upload graphics such as a logo, a personal photograph and then generates a web page based on the member's input. One the design is complete, the member's business ad web page is stored on the web server 22 and the location of the page is correlated with the member's identification. The web server then generates the display illustrated in FIG. 5, displaying the member's newly created business ad web page. The password entry box is preferably designed so that the password is not displayed while being typed into the entry.

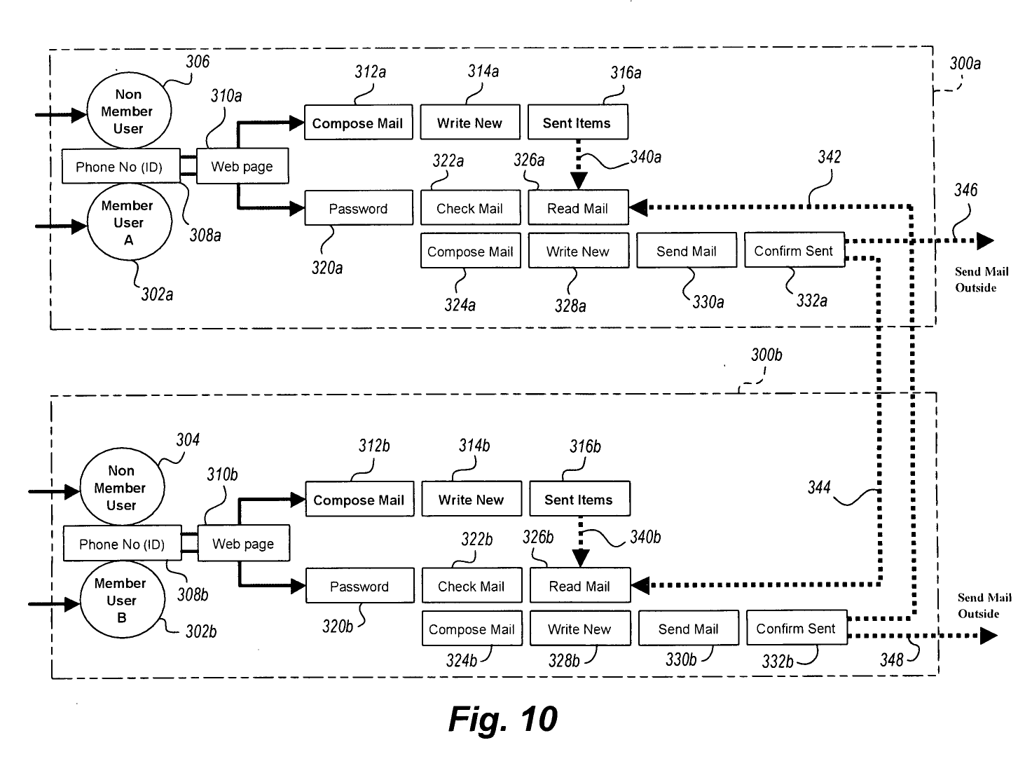

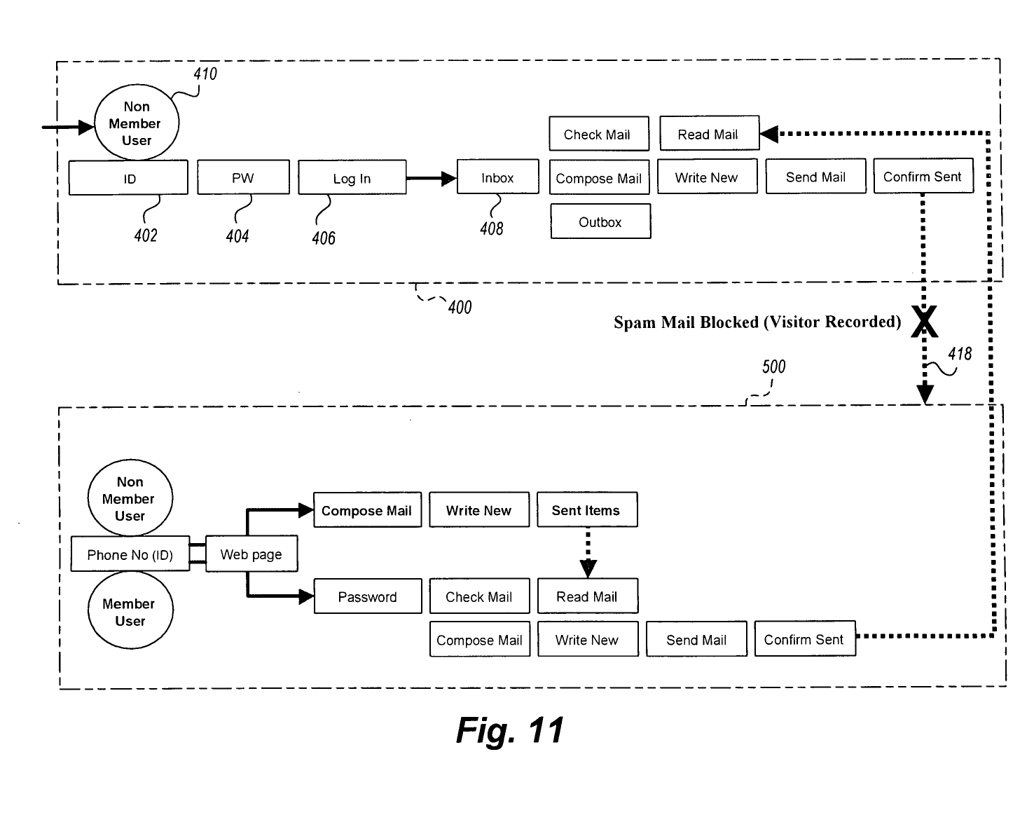

By referring to FIGS. 10 and 11, the mail sending and receiving facilities of the search free mail system may be understood. Beginning with FIG. 10, the process of sending e-mail between a non-member and a member will be detailed. Facilities associated with a member A's account are shown within dotted line 300a while facilities associated with a second member B's account are shown within dotted line 300b. Non-members such as users 304 and 306 can log in to the account of a member 302a or 302b using the respective member's telephone number (blocks 308a and 308b). As described above, the result of the log in will be the display of the member's web page (blocks 310a and 310b). From the member's web page, the non-member users 304 and 306 have access to the publicly available functionality, the non-members can select the composing e-mail function (blocks 312a and 312b) from which the non-members can write e-mails (blocks 314a and 314b) and send the e-mails (blocks 316a and 316b) to the respective members account via paths 340a or 340b. As previously above, requiring a non-member sender to log in to a member's account in order to send mail to the member eliminates the possibility of sending bulk mail to a member's account. The non-member user is able to send e-mail only to the member's account into whose business ad web page he has logged. For example, a non-member 304 logged into the business ad web page 310a of member A 302a, cannot address mail to the account of member B 302b, without first logging out of member A's page and logging into member B's web page 310b because the search free mail facility automatically addresses non-member mail with the address of the member's account.

Members may log into the account of other members using the non-member facilities, but member users have access to more extensive electronic mail functions by logging into their own accounts using their own phone numbers (blocks 308a and 308b). The members may reach their mail accounts by entering their passwords on their respective business ad web page (blocks 310a or 310b), which as described above will provide the member with access to the member's respective mail account. The member may check the mail server for new mail (blocks 322a or 322b), read the member's mail (blocks 326a or 326b), or elect to compose mail (blocks 324a or 324b).

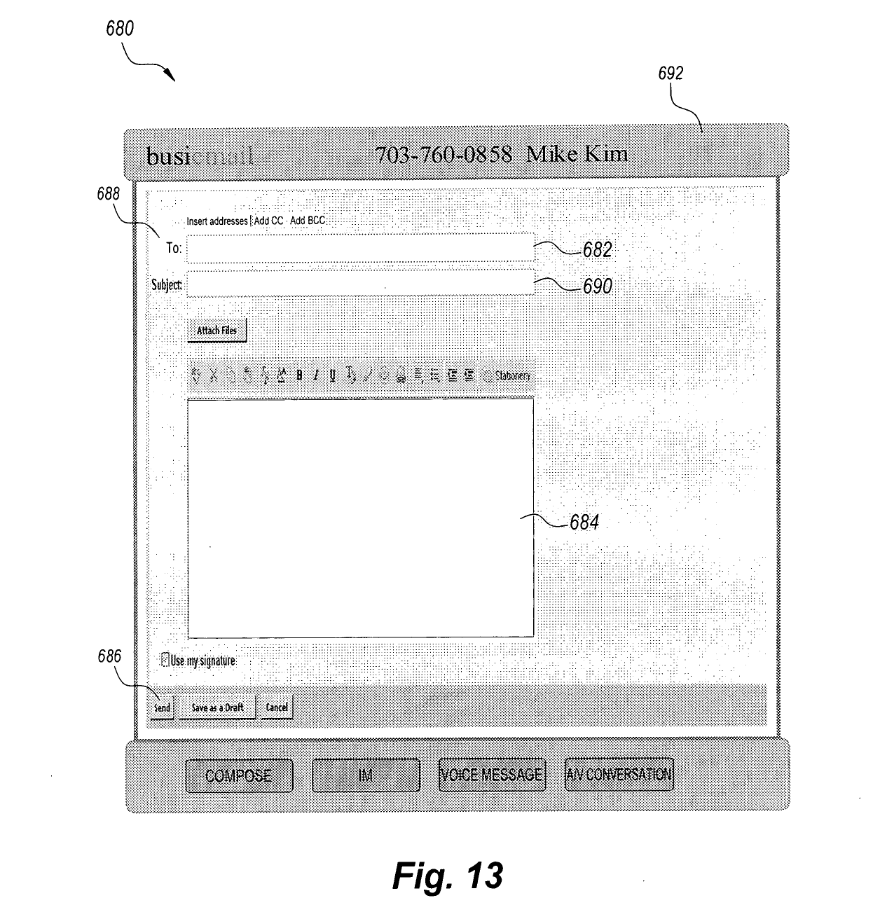

Referring to FIG. 13, the member's facility for composing mail may be understood. The display for 680 for the member's mail facility includes a title bar 692 indicating the name of the account member. The “From” address is specified automatically by the system to be the member's name and search free mail address. The display includes an address entry box 682 for specifying one or more destination addresses. The member may specify addresses both internal to an external to the search free domain system. The label 688 for the mail indicates “To” rather than “From” as for the non-member's mail facility. Once the member has completed composing the mail by specifying the destination addresses and typing the text of the message into the message entry box 684 the message is submitted for delivery by pressing the “Send” button 686. Delivery of e-mail to addresses outside of the search mail domain is via conventional Internet based mail facilities residing on the mail server 24 shown in FIG. 1. Mail addressed to members within the search free domain is stored directly to the respective member's search free domain mailbox. Members are deterred from using the system to send bulk e-mails to members because sending members' mail addresses are included with each outgoing mail. The search mail system may also maintain a log of mailing activity in order to track patterns of abuse such as bulk mailing to addresses internal or external to the search free mail domain.

Referring again to FIG. 10, members once accessing their mail accounts by entering their passwords (blocks 320a and 320b) have access to the facility to compose mail (blocks 324a or 324b). Members may write new mails (blocks 328a and 328b), send those mails (blocks 330a and 330b) and receive confirmation that the mail has been sent as intended (blocks 332a and 332b). Members may send e-mail to the mailboxes of other members via paths 344 or 342. As described above, members may send mail to external addresses via paths 346 or 348.

FIG. 11 illustrates communication between a search free mail domain account 500, and a mail account 400 hosted by a conventional electronic mail provide such as Yahoo.com or hotmail.com. Search free mail member account 500 is identical the member accounts 300a and 300b shown in FIG. 10. A registered member of the conventional account 410 logs in to his account by entering his identification (block 402), password (block 404). Typically the identification is an e-mail address assigned by the e-mail provider. The conventional electronic mail system verifies the password and logs the user into the system (block 406). From this point member 410 can access his mailbox (block 408) to read, compose, and send new mail. If the user of the conventional mail system attempts to address mail to the mailbox of a member of the search free mail system 500 via path 418, the conventional system member will be unsuccessful in the attempt because as described above the search free mail system will not deliver mail using conventional Internet mailing facilities to a search free mail system member's inbox.

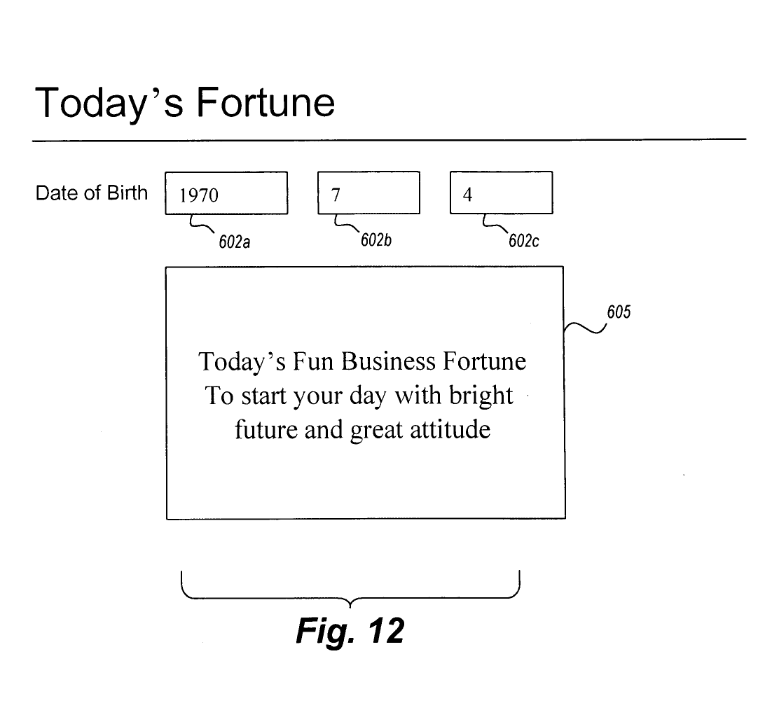

Referring again to FIG. 4, the login display includes a button labeled “Today's Fortune” 146, clicking this button 146 provides access to a function available to visitors to the site who are non-members and are not intending to send mail to search free main domain members. When the “Today's Fortune” button 146 is clicked, the web server generates or retrieves the web page shown in FIG. 12. To access the fortune, the visitor enters a date of birth in the birth date entry boxes 602a-602c. The web server retrieves the information entered by the user and displays a daily fortune 605 based on the data entered by the visitor. The display may also include information about the search free mail domain to encourage visitors to become members.

As described above, all mail composed using the search free mail system addressed to a member is delivered to that member. Alternatively, facilities may be provided for filtering mail addressed to a member. As would be appreciated by those skilled in the art, the filtering may be based on the sender's address or keywords in the subject line or text of the e-mail.

The identifiers used to access the account are described above as telephone numbers. Alternatively any other uniquely assigned information may be used as the identifier for the account. Preferably the identifier is readily obtainable from public information so that the problem of searching for the identifier is not introduced.

It is to be understood that the present invention is not limited to the embodiments described above, but encompasses any and all embodiments within the scope of the following claims.

I claim:

1. A method of composing search free mail, comprising the steps of:
providing a search free mail domain accessible from the Internet, the domain including a mail server having at least one mail server storage device for hosting mailboxes associated with members registered with the search free mail domain, the domain further including a web server having at least one web server computer for generating web pages and delivering web pages to computers over the Internet;
at the search free mail domain, receiving a first input from a user computer, the first input including an identifier of a member registered with the search free mail domain;
sending from the search free mail domain to the user computer a business ad web page associated with the member identifier, the business ad web page including a password entry box for entering a password and means for sending a request by a user to compose an e-mail for sending to the member;
receiving a request from the user computer to compose an e-mail for sending to the member;
receiving a composed e-mail from the user computer; and
storing the composed e-mail in a mailbox associated with the member.

2. The method of composing search free mail according to claim 1, wherein the business ad web page further comprises a link to a company or business web page associated with the member identifier.

3. The method of composing search free mail according to claim 1, wherein the identifier of the member registered with the search free mail domain is a telephone number associated with the member.

4. The method for composing search free mail according to claim 1, further comprising the step of registering a user as member with the search free email domain, said registering step including the steps of:
receiving a member identification from a user computer associated with user;
receiving a password from the user computer;
reserving a location on the mail server for a mailbox;
identifying a business ad web page; and
storing an association of the password, the member identification, the mailbox location and the business ad web page.

5. The method for composing search free mail according to claim 4, wherein the step of registering the user as a member further comprises the steps of:
at the search free domain, sending a request to the user to specify a payment means;
receiving at the search free domain a payment means specified by the user; and
storing at the search free domain an association of the specified payment means with the member identification.

6. The method for composing search free mail according to claim 4, wherein the step of identifying a business ad web page comprises the steps of:
receiving from the user computer information describing content for the business ad web page; and
adding content to the business ad web page based on the information from the user describing the content for the business ad web page.

7. The method for composing search free mail according to claim 1, wherein the step of receiving a first input from a user computer comprises the steps of:
sending to the user computer a log in web page for transmitting a member identification from the user computer to the search free mail domain; and
receiving the member identifier from the user computer.

8. The method for composing search free mail according to claim 7, wherein the log in web page comprises:
member identifier entry means for receiving the member identifier from the user;
means for transmitting a request from the user to become a member of the search free mail domain; and
means for transmitting a user request to log in to the business ad web page associated with the member.

9. A method for composing search free mail, comprising the steps of:
providing a search free mail domain accessible from the Internet, the domain including a mail server having at least one mail server storage device for hosting mailboxes associated with members registered with the search free mail domain, the domain further including a web server having at least one web server computer;
at the search free mail domain, receiving a first input from a user computer, the first input including an identifier of a member registered with the search free e-mail domain; and
sending from the search free mail domain to the user computer a business ad web page associated with the member identifier, the business ad web page including a password entry box for entering a password and means for accepting a request at the user computer to compose an e-mail for sending to the member.

10. The method for composing search free mail according to claim 9, further comprising the steps of:
receiving from a computer associated with a first member the member identifier associated with the first member;
receiving from the computer associated with the first member a password;
verifying the password;
sending to the computer associated with the first member a user interface for composing an e-mail;
receiving from the user computer e-mail information including destination information for the e-mail and the text of a message for a recipient associated with the destination information; and
delivering the e-mail information to the destination associated with the destination information.

11. The method for composing search free mail according to claim 10, wherein the destination information comprises an e-mail address associated with the destination.

12. he method for composing search free mail according to claim 10, wherein the destination information comprises a member identifier of a second member and wherein the step of delivering the e-mail to the destination associated with the destination information further comprises storing the e-mail in a mailbox associated with the member identifier of the second member in the search free e-mail domain.

13. The method for composing search free mail according to claim 10, wherein the step of verifying the password further comprises verifying that the password matches a stored password associated with the member identifier on the search free mail domain.

14. The method for composing search free mail according to claim 10, further comprising the step of verifying an account status associated with the identifier of the member.

15. The method for composing search free mail according to claim 10, wherein the step of verifying an account status associated with the identifier of the member further comprises verifying that a payment status associated with the identifier of the member is current.

16. A system for composing search free mail, comprising a search free mail domain accessible from the Internet, the domain including:
a mail server having at least one mail server storage device for hosting mailboxes associated with members registered with the search free e-mail domain;
a web server having at least one web server computer;
web page means for receiving a first input from a user computer, the first input including an identifier of a member registered with the search free mail domain;
means for storing business ad web pages associated with the identifiers of members registered with the search free domain, each business ad web page having:
a password entry box for entering a password; and
means for sending a request by a user to compose an e-mail for sending to the member;
means for receiving a request from the user computer to compose an e-mail for sending to the member;
means for receiving a composed e-mail from the user computer; and
means for storing the composed e-mail in a mailbox associated with the member.

17. The system for composing search free mail according to claim 16, wherein the member identifier is a telephone number associated with the member.

18. The system for composing search free mail according to claim 16, wherein the business ad web page further comprises a link to a company or business web page associated with the member identifier.

19. The system for composing search free mail according to claim 16, further comprising means for registering a user as member with the search free email domain, the means for registering including:
web page means for receiving a member identifier from a user computer associated with user;
means for generating a web page including a password entry box for receiving a password from the user computer;
means for reserving a location on the mail server for a mailbox;
means for identifying a business ad web page; and
storage means on the web server for storing an association of the password, the member identifier, the mailbox location and the business ad web page.
